(19) United States
(12) Patent Application Publication
(10) Pub. No.: US 2008/0190502 A1
(43) Pub. Date: Aug. 14, 2008

(54) Valve Assembly, in Particular Inlet Valve of a High-Pressure Fuel Pump

(76) Inventors: Ulrich Maier, Reutlingen (DE); Sascha Ambrock, Fachbach (DE); Peter Bauer, Schwieberdingen (DE); Achim Koehler, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/581,415

(22) PCT Filed: Oct. 21, 2004
(86) PCT No.: PCT/DE04/02343

§ 371 Date: Jun. 2, 2006

(30) Foreign Application Priority Data
Dec. 10, 2003 (DE) 103 57 612.6

(51) Int. Cl. F15C 1/16

(52) U.S. Cl. 137/808

(57) ABSTRACT

A valve assembly of a high-pressure fuel pump includes a valve element disposed in a valve chamber and a fluid conduit adjoining the valve chamber upstream. The fluid conduit is embodied such that in at least some portions a rotation (swirl) about a longitudinal axis of the fluid conduit is impressed on the fluid stream that flows toward the valve chamber.

### PRIOR ART

The invention relates to a valve assembly, in particular an inlet valve assembly of a high-pressure fuel pump, having a valve element disposed in a valve chamber and having a fluid conduit adjoining the valve chamber on the upstream side.

A valve assembly of the type defined at the outset is known on the market. It is used for instance in a high-pressure fuel pump of a common rail injection system. This kind of high-pressure fuel pump is embodied as a piston pump. A ball check valve is provided as an inlet valve to a pumping chamber. The ball of the check valve is disposed in a valve chamber, into which an inlet bore discharges. The inlet bore includes a first conduit portion, which is located substantially perpendicular to the longitudinal axis of a piston of the piston pump, and a second conduit portion, which is coaxial to the longitudinal axis of the piston of the piston pump. The longitudinal axes of the two conduit portions intersect in an intersecting region. In this intersecting region, during piston pump operation the fuel flowing toward the inlet valve experiences a sharp deflection.

The object of the present invention is to refine a valve assembly of the type defined at the outset such that it works with as little loss as possible, and as a result the efficiency, for instance of a high-pressure fuel pump in which the valve assembly is used, becomes better.

This object is attained in a valve assembly of the type defined at the outset in that the fluid conduit is embodied such that a rotation (swirl) about the longitudinal axis of the fluid conduit is impressed on the fluid stream that flows toward the valve chamber.

### ADVANTAGES OF THE INVENTION

The rotation (“swirl” or “spin”) impressed on the flow leads to centrifugal forces, by which the flow is pressed against the wall. In this way, the fluid stream is prevented from detaching from the wall of the fluid conduit, for instance in the event of a change of direction causing the formation of a low-pressure zone. As a result, the dynamic pressure in the deflection region is reduced, and the flow resistance is lowered. Cavitation damage in the fluid conduit is also avoided. Because of the fluid stream pressing against the wall of the fluid conduit, the fluid conduit is filled uniformly, which leads to higher throughput for the same opening duration of the valve element.

Because the flow presses against the wall at all times, the length of the fluid conduit can also be made shorter, which reduces the overall size of the valve assembly and for instance a fuel pump in which the valve assembly is used. Because a spin is imposed on the flow, otherwise pronounced unsteady turbulent flow events (pulsating speed profile) are reduced or prevented entirely, which lessens the load on the fluid conduit and on a region located farther upstream. Hence a supply pump that carries the fluid to the valve assembly is for instance also protected.

Because the flow in the fluid conduit is made more uniform, the valve element itself is also bathed uniformly by the flow and thus even in the opened floating state remains centrally located; in other words, no shear force on the valve is exerted by a fluid flowing past it on one side. Once again, the result is improved efficiency of the valve assembly and less wear of the valve element.

Advantageous refinements of the invention are defined by the dependent claims.

It is proposed that the fluid conduit includes a first conduit portion and adjoining it a second conduit portion, and the longitudinal axes of the conduit portions are at an angle <180° to one another, and the longitudinal axis of the first conduit portion is laterally offset from the longitudinal axis of the second conduit portion. As a result of the lateral offset, the rotation of the flow in the second conduit portion is brought about in a simple. Turbulence caused by the kink between the two conduit portions is effectively smoothed, or such turbulence cannot even arise in the first place.

The rotation is especially pronounced whenever the longitudinal axes of the two conduit portions are at least approximately at a right angle to one another. In this case, the spin impressed on the flow in the second conduit portion is the greatest, and the advantages attainable with the valve assembly of the invention are therefore also the greatest.

It is also proposed that the valve assembly includes a ball or a cone element as the valve element. Because of the rotary motion of the fluid flowing to the valve chamber, these rotationally symmetrical valve elements are also set into rotation. This prevents unilateral wear of these valve elements and increases the durability of a valve seat associated with the valve element.

An especially preferred embodiment of the valve assembly of the invention is distinguished in that both conduit portions in cross section have at least approximately the same radius, and that the lateral offset of the longitudinal axes is greater than the radius. This simplifies the manufacture of the valve assembly of the invention and thus reduces the production costs, since the same drilling tool can be used for both conduit portions.

It is also proposed that a transition region between the first conduit portion and the second conduit portion is machined by means of electrochemical removal of material. This makes for a largely edge-free transition from one conduit portion to the other conduit portion, which is likewise favorable for the sake of a uniform flow.

It is especially preferred if the transition region includes a wall that is curved from the first conduit portion to the second conduit portion. This leads to an especially calm flow, in which little turbulence occurs.

It is also especially preferred if the first conduit portion extends axially past the second conduit portion only insignificantly, if at all. As a result, the dynamic pressure upstream of the deflection from the first conduit portion to the second conduit portion is reduced, which further reduces the flow resistance and improves the overall efficiency of the valve assembly from the fluidic standpoint.

It is also possible that the longitudinal axis of the first conduit portion and the longitudinal axis of the second conduit portion form an angle >90°. This leads to an additional reduction in resistance.

### DRAWINGS

Below, an especially preferred exemplary embodiment of the present invention is described in further detail, in conjunction with the accompanying drawings. In the drawings:

FIG. 1 is a schematic illustration of an internal combustion engine with a high-pressure fuel pump;

FIG. 2 shows a section through a housing of the high-pressure fuel pump of FIG. 1;

FIG. 3 is a section taken along the line III-III in FIG. 2;

FIG. 4 is a detail inlet valve of FIG. 2;

FIG. 5 is a section taken along the line V-V in FIG. 4;

FIG. 6 is a section taken along the line VI-VI in FIG. 4;

FIG. 7 is a section taken along the line VII-VII in FIG. 4; and

FIG. 8 is a view similar to FIG. 3 of a modified embodiment of a housing of the high-pressure fuel pump of FIG. 1.

### DESCRIPTION OF THE EXEMPLARY EMBODIMENTS

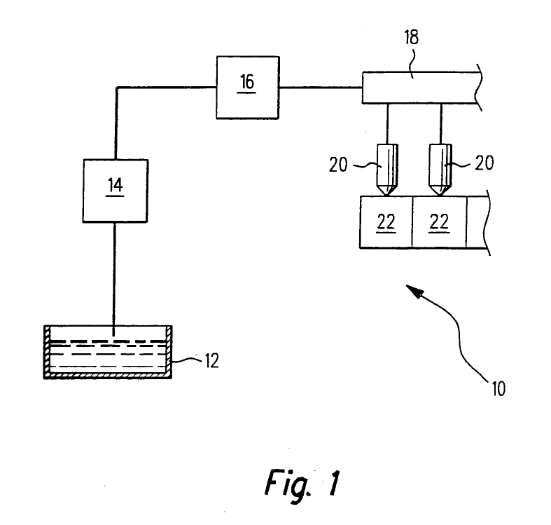

An internal combustion engine is identified in general in FIG. 1 by the reference numeral 10. It includes a fuel tank 12, from which a prefeed pump 14 pumps the fuel to a high-pressure fuel pump 16. This latter pump compresses the fuel to a very high pressure and pumps it to a fuel collection line 18 (“rail”), in which the fuel is stored at high pressure. Connected to it are a plurality of injectors 20, which inject the fuel directly into combustion chambers 22 associated with them.

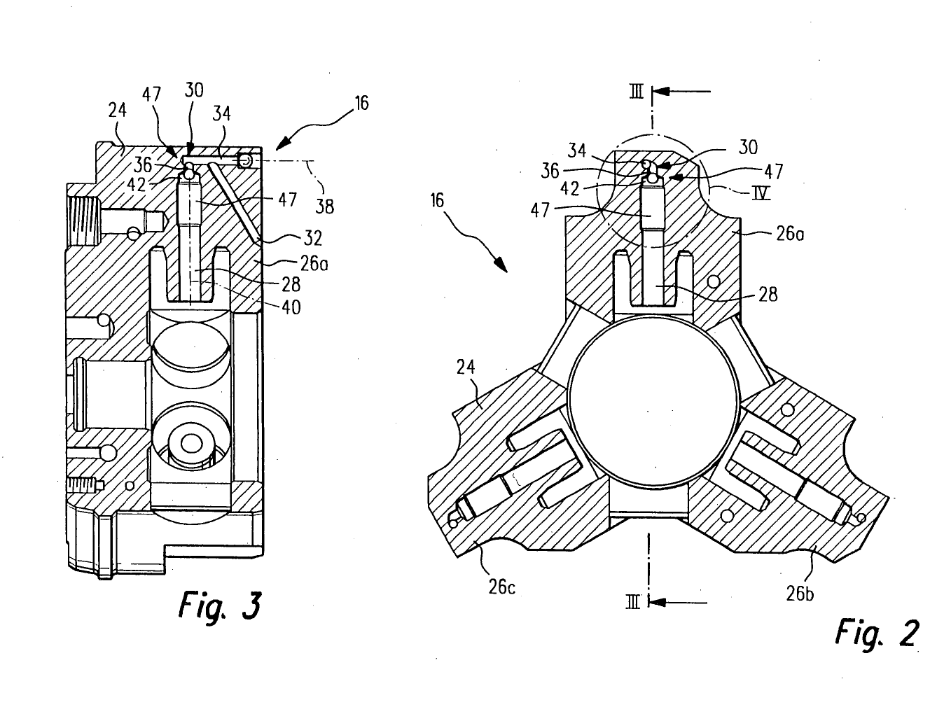

A housing 24 of the high-pressure fuel pump 16 is shown in greater detail in FIGS. 2 and 3. It includes three cylinders 26a, 26b, and 26c, which are embodied substantially identically. For the sake of simplicity, only the cylinder 26a will be referred to below.

In the cylinder 26a, there is a piston bore 28, in which a piston, not shown, is received longitudinally displaceably. Via a fluid conduit 30, the piston bore 28 can be connected to a fuel inlet 32. The fuel inlet 32 communicates in turn with the prefeed pump 14.

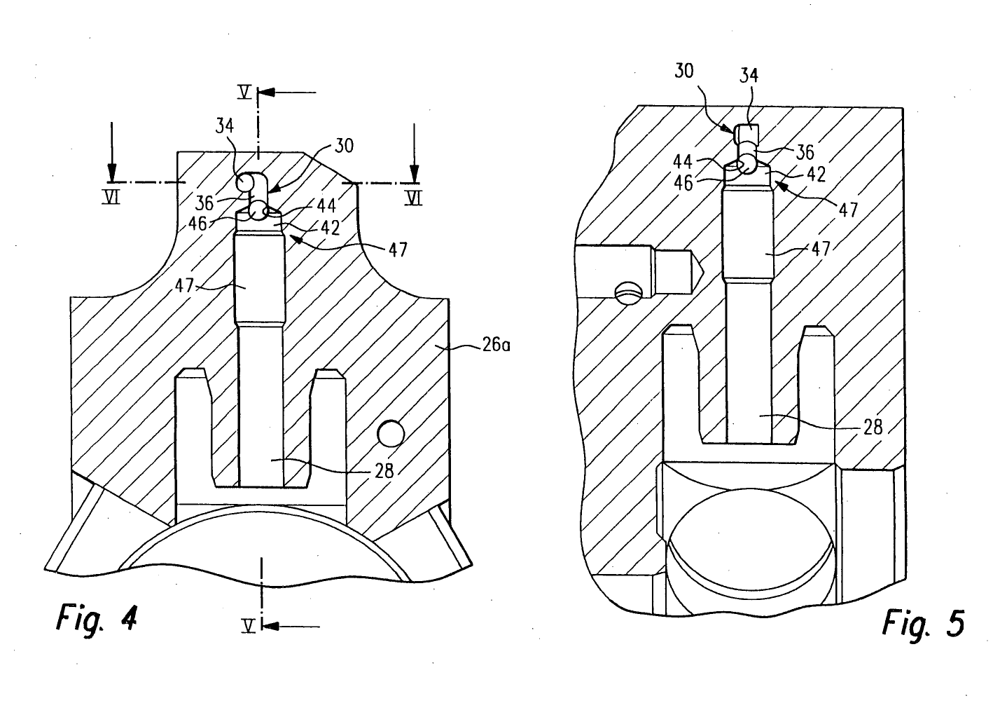

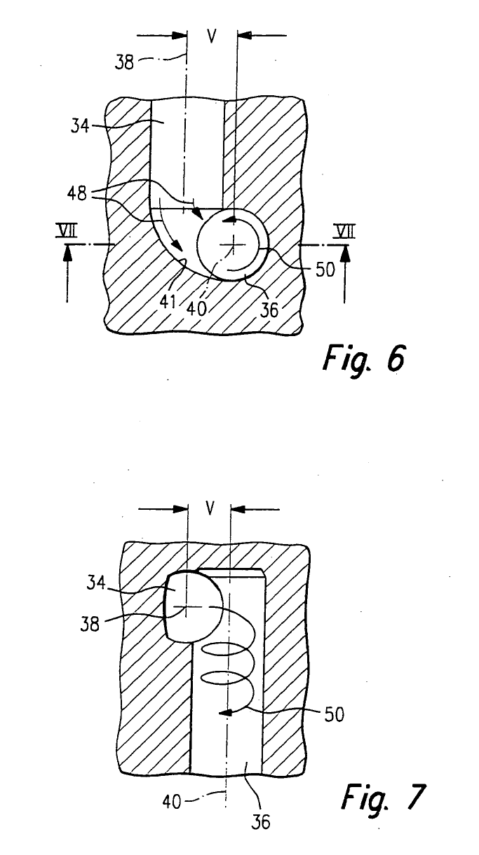

The fluid conduit 28 is divided into two conduit portions 34 and 36. The first conduit portion 34 extends at an angle from an inlet conduit (not identified by reference numeral), which in turn leads away from a fuel inlet 32. The first conduit portion 34 is plugged from the outside by a ball, not identified by a reference numeral. Its longitudinal axis 38 extends perpendicular to the longitudinal axis 40 of the piston bore 28 and of the second conduit portion 36 (see FIG. 3). The two longitudinal axes 38 and 40 do not intersect, however. As can be seen especially from FIGS. 2 and 4 as well as 6 and 7, instead the longitudinal axis 38 of the first conduit portion 34 is laterally offset from the longitudinal axis 40 of the second conduit portion 36. The lateral offset is designated V in FIGS. 6 and 7. The two conduit portions 38 and 40 have the same radius in cross section, and this radius is greater than the lateral offset V of the two longitudinal axes 38 and 40.

As seen particularly from FIG. 6, in a transition region between the first conduit portion 34 and the second conduit portion 36, there is a wall face 41 that is curved from the first conduit portion 34 to the second conduit portion 36. This wall face is machined by means of electrochemical removal of material. Through it, the radially outer wall, in the sectional plane of FIG. 6, of the conduit portion 34 changes over without a kink or an edge into the corresponding wall portion of the conduit portion 36.

Between the second conduit portion 36 of the fluid conduit 30 and the piston bore 28, there is a valve chamber 42. Between the valve chamber 42 and the second conduit portion 36, a shoulder is formed, which forms a valve seat 44 for a valve ball 46 that is received in the valve chamber 42 (see FIGS. 4 and 5). The valve ball 46 is urged against the valve seat 44 by a spring not shown in the drawing. The valve chamber 42 is adjoined by a pumping chamber 47. As can be seen particularly from FIG. 7, the first conduit portion 34 hardly extends past the second conduit portion 36. The fluid conduit 30, the valve seat 44, and the valve ball 46 together form a valve assembly 47.

The high-pressure fuel pump 16 functions as follows (once again, only cylinder 26a will be referred to):

Upon an intake stroke of the piston, the valve ball 46 lifts from the valve seat 44. Fuel now flows from the prefeed pump 14, via the fuel inlet 32, the first conduit portion 34, the second conduit portion 36, and through the gap between the valve ball 46 and the valve seat 44, into the valve chamber 42 and onward into the pumping chamber 47. Because of the offset V between the longitudinal axis 38 of the first conduit portion 34 and the longitudinal axis 40 of the second conduit portion 36, the fluid stream experiences a lateral motion component (arrows 48 in FIG. 6). This lateral motion component is reinforced by the curved wall 41, without the capability that a substantial dynamic pressure could build up as a result in the first conduit portion 34.

From the first conduit portion 34, the fuel reaches the second conduit portion 36. In the process it experiences a change of direction of 90°. However, because of the lateral motion component 48, in the second conduit portion 36 a rotary motion about the longitudinal axis 40 of the second conduit portion 36 is established in the fluid stream. This rotary motion is also known as “swirl” or “spin” and is identified by reference numeral 50 in FIGS. 6 and 7. As a result of the spin 50, upon a change of direction of the fluid stream in the transition region between the first conduit portion 34 and the second conduit portion 36, detachment of the flow, which would lead to increased flow resistance as well as the risk of cavitation and corresponding wear, is prevented.

Also because of the spin 50, the valve ball 46 is set into rotation in the open state, so that it wears evenly. Thus its sealing action and the sealing action of the valve seat 44 are preserved over a very long period of time. Since a detachment of the fuel stream in the transition region between the two conduit portions 34 and 36, and especially in the second conduit portion 36, is prevented, a constriction of the fluid stream with a correspondingly reduced hydraulic diameter, which would lead to increased throttling, is also averted.

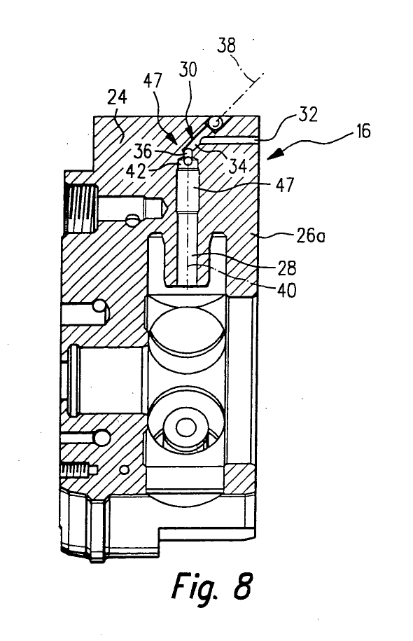

An alternative embodiment is shown in FIG. 8. Those elements and regions that have equivalent functions to elements and regions of the previous drawings are identified by the same reference numerals. They are not described again in detail. In contrast to the first exemplary embodiment, here the longitudinal axis 38 of the first conduit portion 34 is not at an angle of 90° but rather at an angle of approximately 45° to the longitudinal axis 40 of the second conduit portion 36. As a result, a more-favorable flow, or in other words a flow with less resistance, is additionally achieved.

1-9. (canceled)

10. In an inlet valve assembly of a high-pressure fuel pump comprising a valve element disposed in a valve chamber and a fluid conduit adjoining the valve chamber on the upstream side, the improvement wherein the fluid conduit is embodied such that a rotation (swirl) about the longitudinal axis of the fluid conduit is impressed on the fluid stream that flows toward the valve chamber.

11. The valve assembly as recited in claim 10, wherein the fluid conduit comprises a first conduit portion and a second conduit portion adjoining the first conduit portion, the longitudinal axes of the first and second conduit portions being at an angle <180° to one another, and the longitudinal axis of the first conduit portion being laterally offset from the longitudinal axis of the second conduit portion.

12. The valve assembly as recited in claim 11, wherein the longitudinal axes of the first and second conduit portions are at least approximately at a right angle to one another.

13. The valve assembly as recited in claim 10, further comprising a ball or a cone element as the valve element.

14. The valve assembly as recited in claim 11, further comprising a ball or a cone element as the valve element.

15. The valve assembly as recited in claim 12, further comprising a ball or a cone element as the valve element.

16. The valve assembly as recited in claim 11, wherein the first and second conduit portions, in cross section, have at least approximately the same radius; and wherein the lateral offset of the longitudinal axes is greater than the radius.

17. The valve assembly as recited in claim 12, wherein the first and second conduit portions, in cross section, have at least approximately the same radius; and wherein the lateral offset of the longitudinal axes is greater than the radius.

18. The valve assembly as recited in claim 13, wherein the first and second conduit portions, in cross section, have at least approximately the same radius; and wherein the lateral offset of the longitudinal axes is greater than the radius.

19. The valve assembly as recited in claim 11, further comprising a transition region between the first conduit portion and the second conduit portion, the transition region being machined by means of electrochemical removal of material.

20. The valve assembly as recited in claim 12, further comprising a transition region between the first conduit portion and the second conduit portion, the transition region being machined by means of electrochemical removal of material.

21. The valve assembly as recited in claim 13, further comprising a transition region between the first conduit portion and the second conduit portion, the transition region being machined by means of electrochemical removal of material.

22. The valve assembly as recited in claim 16, further comprising a transition region between the first conduit portion and the second conduit portion, the transition region being machined by means of electrochemical removal of material.

23. The valve assembly as recited in claim 19, wherein the transition region comprises a wall that is curved from the first conduit portion to the second conduit portion.

24. The valve assembly as recited in claim 20, wherein the transition region comprises a wall that is curved from the first conduit portion to the second conduit portion.

25. The valve assembly as recited in claim 21, wherein the transition region comprises a wall that is curved from the first conduit portion to the second conduit portion.

26. The valve assembly as recited in claim 22, wherein the transition region comprises a wall that is curved from the first conduit portion to the second conduit portion.

27. The valve assembly as recited in claim 11, wherein the first conduit portion extends no more than an axially insignificantly distance past the second conduit portion.

28. The valve assembly as recited in claim 10, wherein the longitudinal axis of the first conduit portion and the longitudinal axis of the second conduit portion form an angle >90°.

29. The valve assembly as recited in claim 11, wherein the longitudinal axis of the first conduit portion and the longitudinal axis of the second conduit portion form an angle >90°.
